(19) United States
(12) Patent Application Publication
(10) Pub. No.: US 2026/0150098 A1
(43) Pub. Date: May 28, 2026

(54) TECHNIQUES FOR INDICATING MULTIPLE TCI STATES

(71) Applicant: Lenovo (United States) Inc., Morrisville, NC (US)

(72) Inventors: Khaled Nafez Rauf Ardah, Ilmenau (DE); Karthikeyan Ganesan, Kronberg im Taunus (DE); Ali Ramadan Ali, Kraiburg am Inn (DE)

(21) Appl. No.: 18/957,290

(22) Filed: Nov. 22, 2024

(51) Int. Cl. H04W 72/1263; H04W 72/0453

(52) U.S. Cl. CPC H04W 72/1263; H04W 72/0453

(57) ABSTRACT

Various aspects of the present disclosure relate to techniques for indicating multiple TCI states. An apparatus is configured to receive a first configuration message comprising an indication of one or more transmission configuration indicator (TCI) state sets, wherein each TCI state set of the one or more TCI state sets comprises one or more TCI states; receive a second configuration message comprising configuration information for scheduling a downlink or uplink channel or signal, wherein frequency resources that are allocated to a scheduled downlink or uplink channel or signal comprise a plurality of channel or signal parts, and wherein the second configuration message further comprises an indication of a plurality of TCI states; and communicate in accordance with processing the plurality of channel or signal parts of the scheduled downlink or uplink channel or signal using the plurality of TCI states.

### TECHNICAL FIELD

The present disclosure relates to wireless communications, and more specifically to techniques (e.g., methods, designs) for indicating multiple transmission configuration indicator (TCI) states.

### BACKGROUND

A wireless communications system may include one or multiple network communication devices, such as base stations, which may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A user equipment (UE) for wireless communication is described. The UE may be configured to, capable of, or operable to receive a first configuration message comprising an indication of one or more TCI state sets, wherein each TCI state set of the one or more TCI state sets comprises one or more TCI states; receive a second configuration message comprising configuration information for scheduling a downlink channel or signal or an uplink channel or signal, wherein frequency resources that are allocated to a scheduled downlink channel or signal or a scheduled uplink channel or signal comprise a plurality of channel parts or signal parts, and wherein the second configuration message further comprises an indication of a plurality of TCI states associated with the plurality of channel parts or signal parts of the scheduled downlink channel or signal or the scheduled uplink channel or signal; and communicate in accordance with processing the plurality of channel parts or signal parts of the scheduled downlink channel or signal or the scheduled uplink channel or signal using the associated plurality of TCI states.

A method for wireless communication performed by a UE. The method may be configured to receive a first configuration message comprising an indication of one or more TCI state sets, wherein each TCI state set of the one or more TCI state sets comprises one or more TCI states; receive a second configuration message comprising configuration information for scheduling a downlink channel or signal or an uplink channel or signal, wherein frequency resources that are allocated to a scheduled downlink channel or signal or a scheduled uplink channel or signal comprise a plurality of channel parts or signal parts, and wherein the second configuration message further comprises an indication of a plurality of TCI states associated with the plurality of channel parts or signal parts of the scheduled downlink channel or signal or the scheduled uplink channel or signal; and communicate in accordance with processing the plurality of channel parts or signal parts of the scheduled downlink channel or signal or the scheduled uplink channel or signal using the associated plurality of TCI states.

A processor for wireless communication is described. The processor may be configured to, capable of, or operable to receive a first configuration message comprising an indication of one or more TCI state sets, wherein each TCI state set of the one or more TCI state sets comprises one or more TCI states; receive a second configuration message comprising configuration information for scheduling a downlink channel or signal or an uplink channel or signal, wherein frequency resources that are allocated to a scheduled downlink channel or signal or a scheduled uplink channel or signal comprise a plurality of channel parts or signal parts, and wherein the second configuration message further comprises an indication of a plurality of TCI states associated with the plurality of channel parts or signal parts of the scheduled downlink channel or signal or the scheduled uplink channel or signal; and communicate in accordance with processing the plurality of channel parts or signal parts of the scheduled downlink channel or signal or the scheduled uplink channel or signal using the associated plurality of TCI states.

A network equipment (NE) for wireless communication is described. The NE may be configured to, capable of, or operable to determine one or more TCI state sets comprising one or more TCI states; transmit a first configuration message comprising an indication of the one or more TCI state sets; determine information for scheduling a downlink channel or signal or an uplink channel or signal, wherein frequency resources that are allocated to the scheduled downlink channel or signal or uplink channel or signal comprise a plurality of channel parts or signal parts; determine a plurality of TCI states associated with the plurality of channel parts or signal parts of the scheduled downlink channel or signal or uplink channel or signal; and transmit a second configuration message comprising the information for scheduling the downlink channel or signal or uplink channel or signal and an indication of the plurality of TCI states associated with the plurality of channel parts or signal parts.

Another method for wireless communication performed by a NE. The method may be configured to determine one or more TCI state sets comprising one or more TCI states; transmit a first configuration message comprising an indication of the one or more TCI state sets; determine information for scheduling a downlink channel or signal or an uplink channel or signal, wherein frequency resources that are allocated to the scheduled downlink channel or signal or uplink channel or signal comprise a plurality of channel parts or signal parts; determine a plurality of TCI states associated with the plurality of channel parts or signal parts of the scheduled downlink channel or signal or uplink channel or signal; and transmit a second configuration message comprising the information for scheduling the downlink channel or signal or uplink channel or signal and an indication of the plurality of TCI states associated with the plurality of channel parts or signal parts.

Another processor for wireless communication is described. The processor may be configured to, capable of, or operable to determine one or more TCI state sets comprising one or more TCI states; transmit a first configuration message comprising an indication of the one or more TCI state sets; determine information for scheduling a downlink channel or signal or an uplink channel or signal, wherein frequency resources that are allocated to the scheduled downlink channel or signal or uplink channel or signal comprise a plurality of channel parts or signal parts; determine a plurality of TCI states associated with the plurality of channel parts or signal parts of the scheduled downlink channel or signal or uplink channel or signal; and transmit a second configuration message comprising the information for scheduling the downlink channel or signal or uplink channel or signal and an indication of the plurality of TCI states associated with the plurality of channel parts or signal parts.

### BRIEF DESCRIPTION OF THE DRAWINGS

FIG. 1 illustrates an example of a wireless communications system in accordance with aspects of the present disclosure.

FIG. 2 illustrates an example of a system in accordance with aspects of the present disclosure.

FIG. 3 illustrates an example of beam gain vs. subcarrier index with different system settings in accordance with aspects of the present disclosure.

FIG. 4 illustrates an example of PDSCH channel frequency location/resources with respect to an active BWP and corresponding beam frequency effective regions in accordance with aspects of the present disclosure.

FIG. 5 illustrates an example of BWPs and beam effective regions in accordance with aspects of the present disclosure.

FIG. 6 illustrates an example of TCI indication in accordance with aspects of the present disclosure.

FIG. 7 illustrates an example of TCI indication in accordance with aspects of the present disclosure.

FIG. 8 illustrates an example of TCI indication in accordance with aspects of the present disclosure.

FIG. 9 illustrates an example of TCI indication in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of an NE in accordance with aspects of the present disclosure.

FIG. 13 illustrates a flowchart of method in accordance with aspects of the present disclosure.

FIG. 14 illustrates a flowchart of method in accordance with aspects of the present disclosure.

### DETAILED DESCRIPTION

A wireless communication system may support wireless devices communicating in accordance with one or more TCI state configurations. In 5G new radio (NR), quasi-colocation (QCL) and TCI state are used by a network node, e.g., a gNB to inform a user equipment (UE) about assumptions it can make regarding different channels or signals (e.g., assumptions with reference to a channel state or a signal state). A UE may be configured with one or more TCI states using at least one of radio resource control (RRC) signaling, media access control (MAC) control element (CE) signaling, and downlink control information (DCI) signaling. However, in some wireless communications systems supporting 5G NR, the gNB may indicate one TCI state and the UE may use the single TCI during reception or transmission of a configured or scheduled downlink (DL) or uplink (UL) signal or channel.

In wireless communication systems, it is observed that if the system bandwidth and the number of antenna array elements increases, beam squint issues arise where a beam gain of an analog beamforming vector over a number of system subcarriers becomes very low, approaching zero, and the number of impacted subcarriers increases with the increasing bandwidth and number of antenna array elements. In this case, if a network node is to schedule or configure a DL/UL signal/channel, e.g., a Physical Downlink Shared Channel (PDSCH), to be transmitted to a UE on a wide bandwidth or if a UE changes its beam due to mobility, the network node may need to utilize two or more beams, each corresponding to a different beam frequency effective region. Therefore, it is beneficial to enhance current TCI state frameworks to account for cases where a DL/UL signal/channel is associated with two or more TCI states.

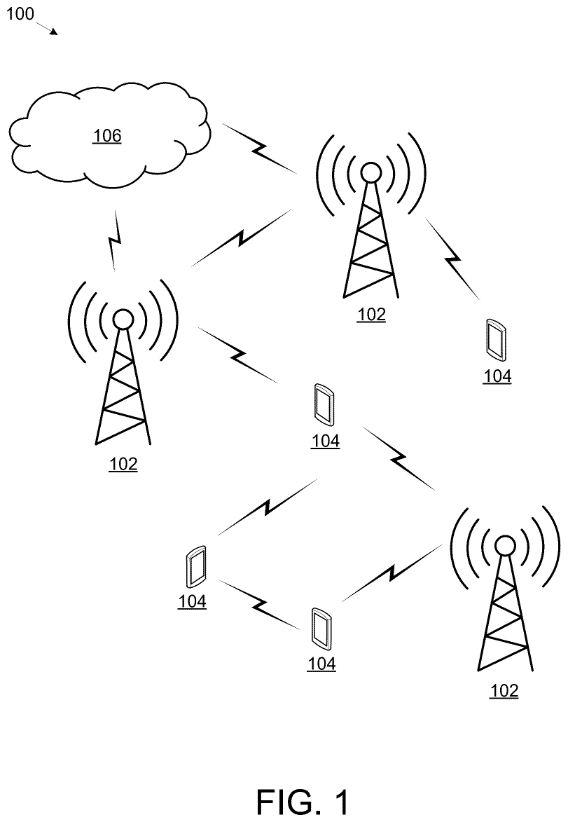

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHz), FR4 (52.6 GHz-114.25 GHZ), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., ρ=0), which includes 15 kHz subcarrier spacing; a second numerology (e.g., μ=1), which includes 30 kHz subcarrier spacing; and a third numerology (e.g., u=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one embodiment, the system 100 shown in FIG. 1 is configured to, capable or, or operable to implement the solutions described herein, namely receive a first configuration message comprising an indication of one or more TCI state sets, wherein each TCI state set of the one or more TCI state sets comprises one or more TCI states; receive a second configuration message comprising configuration information for scheduling a downlink channel or an uplink channel, wherein frequency resources that are allocated to a scheduled downlink channel or a scheduled uplink channel comprise a plurality of parts, and wherein the second configuration message further comprises an indication of a plurality of TCI states associated with the plurality of parts of the scheduled downlink channel or the scheduled uplink channel; and communicate in accordance with processing the plurality of parts of the scheduled downlink channel or the scheduled uplink channel using the associated plurality of TCI states.

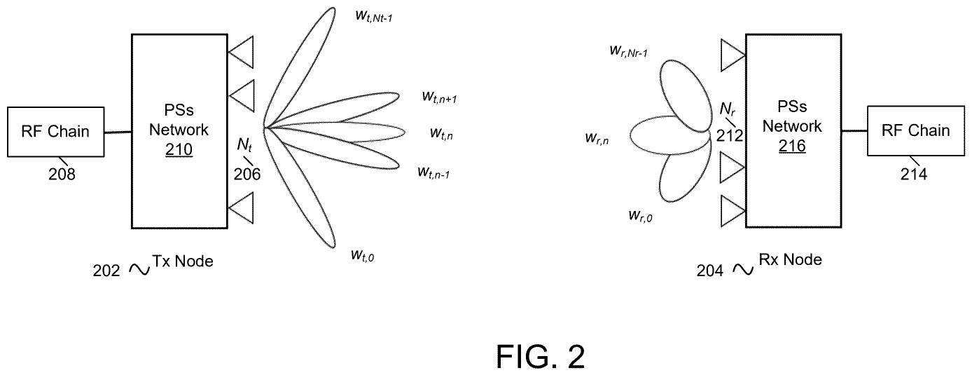

FIG. 2 illustrates an example of a system in accordance with aspects of the present disclosure. In the example embodiment, assume a transmission (Tx) node 202 (e.g., a gNB) communicates with a reception (Rx) node 204 (e.g., UE) using an OFDM based system with M total subcarriers. As depicted herein, SCS denote the subcarrier spacing (SCS), e.g., SCS={15, 30, 60, 120, 240} kHz. In such cases, a total number of subcarriers may be upper bounded as

$$M = ⌈ \frac{B}{SCS} ⌉ .$$

The Tx node 202 has a uniform linear array (ULA) of Nₜ antennas 206 connected to a radiofrequency (RF) chain 208 via Nₜ phase-shifters (PSs) 210 and the Rx node 204 has Nᵣ antennas 212 connected to a RF chain 214 via Nᵣ PSs 216.

As depicted herein, f_{c} denotes the central carrier frequency (e.g., {3.5, 7, 15} GHz) and B denotes the system bandwidth (e.g., {100, 400} MHz). Therefore, the frequency of the mth subcarrier (SC) is given as:

$${f}_{m} = {f}_{c} + \frac{B}{M} ( m - 1 - \frac{M - 1}{2} ) .$$

A half-wavelength inter-element spacing, i.e.,

$$d = \frac{{λ}_{c}}{2} , where {λ}_{c} = \frac{c}{{f}_{c}}$$

is the wavelength of f_{c} and c is the light speed in meters/seconds is assumed. The channel matrix over the mth subcarrier is given as:

$${H}_{m} ( {θ}_{r} , {θ}_{t} ) = {\sum }_{ℓ = 1}^{L} {g}_{ℓ} {e}^{- j 2 {πτ}_{ℓ} {f}_{m}} {v}_{r} ( {f}_{m} , {θ}_{r , ℓ} ) {{v}_{t} ( {f}_{m} , {θ}_{t , ℓ} )}^{T}$$

where L denotes total number of channel paths, [symbol] is the complex path gain of the [symbol] th path, [symbol] is the [symbol] th path delay, [symbol] ∈[−π, π] are the angles of departure and arrival of [symbol] th path. Moreover, vₓ (fₘ, [symbol] ), x∈{t, r} denote the Nₓ×1 antenna steering/response vector of the [symbol] th path, which, for ULAs, is given as

$${v}_{x} ( {f}_{m} , {θ}_{x , ℓ} ) = {\frac{1}{\sqrt{{N}_{x}}} [ 1 , {e}^{j 2 π d \frac{{f}_{m}}{c} sin {θ}_{ℓ}} , ... , {e}^{j 2 π d ( {N}_{x} - 1 ) \frac{{f}_{m}}{c} sin {θ}_{x , ℓ}} ]}^{T}$$

Let

$${ψ}_{x , ℓ} = 2 π d \frac{{f}_{m}}{c} sin {θ}_{x , ℓ} ∈ [ - π , π ] .$$

Then, vₓ (fₘ, θ_{x,l}) simplifies to

$${v}_{x} ( {f}_{m} , {ψ}_{x , ℓ} ) = {[ 1 , {e}^{j {ψ}_{x , ℓ}} , ... , {e}^{j ( N - 1 ) {ψ}_{x , ℓ}} ]}^{T}$$

Let Wₜ=[w_{t,1}, . . . , w_{t,N}_{ₜ}] be the Nₜ×Nₜ analog beamforming codebook at the Tx node and Wᵣ=[w_{r,1}, . . . , w_{r,N}_{ᵣ}] be the Nᵣ×Nᵣ analog beamforming codebook at the Rx node. A natural choice for designing/selecting Wₓ is the normalized Discrete Fourier transform (DFT) matrix, as it uniformly quantizes the angular range [0, 2π], or equivalently [−π, π], with a

$${Δ}_{θ} = \frac{2 π}{{N}_{x}}$$

step size, while maintaining the orthonormality between the different vectors, i.e.,

$${w}_{x , i}^{H} {w}_{x , j} = 0 , ∀ i , j , i \neq j .$$

Let Φₓ=[0, Δ_{θ}, 2Δ_{θ}, . . . , (Nₓ−1)Δ_{θ}] be the vector with the Nₓ angular grid points. Then, the nth normalized vector of the DFT matrix Wₓ can be expressed as

$${w}_{x , n} = {\frac{1}{\sqrt{{N}_{x}}} [ 1 , {e}^{j {ϕ}_{x , n}} , ... , {e}^{j ( {N}_{x} - 1 ) {ϕ}_{x , n}} ]}^{T}$$

where φ_{x,n} is the nth entry of Φₓ.

It is clear that both the DFT matrix vector w_{x,n} and the channel steering/response vector vₓ (fₘ, [symbol] ) have the same structure, known as the Vandermonde structure, and therefore the maximum beam gain, i.e., |vₓ (fₘ, [symbol] )^{H}w_{x,n}∥=1 is achieved when φ_{x,n}= [symbol] . If Tx 202 and Rx 204 nodes know the steering vector angles [symbol] and [symbol] , e.g., via an angle estimation method, then the Tx 202 and Rx 204 nodes can design/select the best transmit and receive beamforming vectors, e.g., the ones maximizing the beam gain. Alternatively, the Tx node 202 may transmit a reference signal using the different beamforming vectors, wherein the Rx node 204 may measure, e.g., their received power, select one or more transmit beams (e.g., the ones with the maximin received power), and feed them back to the Tx node 202, which it may use for a following data communication/transmission.

As it relates to the system shown in FIG. 2, the subject matter herein allows a Tx node 202, e.g., a gNB to use two or more beams, each corresponding to a different beam frequency effective region and enhances the current TCI state framework to account for cases where a DL/UL signal/channel is associated with two or more TCI states.

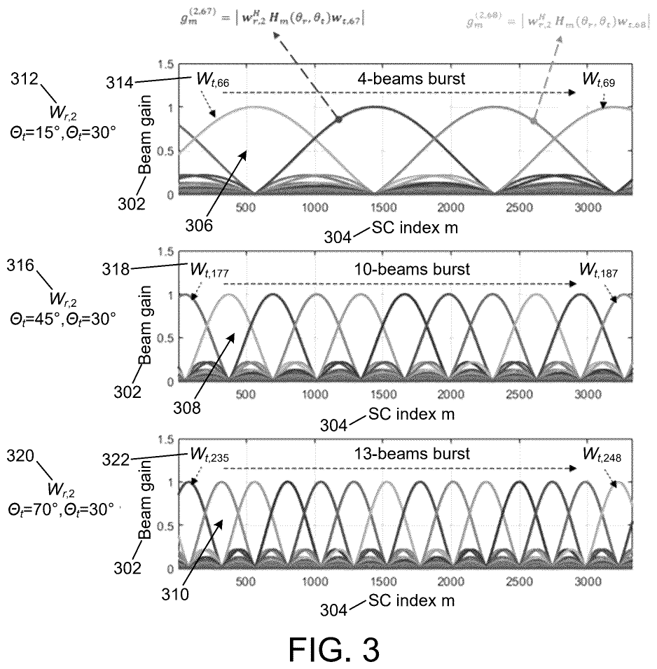

FIG. 3 illustrates an example of beam gain 302 vs. subcarrier index 304 with different system settings in accordance with aspects of the present disclosure. Assume that the Tx node 202 transmits a RS using every beamforming vector, e.g., using a beam sweeping method, wherein at the nth transmission occasion the Tx node 202 uses wₙ to transmit a RS signal. In such an embodiment, the beam gain over all system subcarriers, where the beam gain of (nᵣ, nₜ)th beam pair over the mth subcarrier, is defined as:

$${g}_{m}^{( {n}_{r} , {n}_{t} )} = \vert {w}_{r , {n}_{r}}^{H} {H}_{m} ( {θ}_{r} , {θ}_{t} ) {w}_{t , {n}_{t}} \vert$$

In one embodiment, when the Tx node 202 uses an extremely large number of antennas, e.g., Nₜ=512, and a very large carrier bandwidth, e.g., B=400 MHz, a transmitted beam experiences a “beam squint effect”, where the beam gain, as observed/measured by the Rx node 204, becomes effective over a certain group of subcarriers (called hereafter by “beam frequency effective region”) and decreases sharply over another groups of subcarriers (called hereafter by “beam frequency ineffective regions”). Such an effect appears mainly due to the very narrow beamwidth of the transmitted beams.

As shown in FIG. 3, in one embodiment, the “beam frequency effective region” 306-310 becomes smaller as the angle-of-departure (AoD) increases, i.e., when it becomes more horizontal to the antenna array, and the “beam frequency effective region” 306-310 becomes larger as the AoD decreases, i.e., it becomes more perpendicular to the antenna array.

For example, when

$${θ}_{t} = {15}^{o} = \frac{π}{12} ,$$

312 the “beam frequency effective region” 306 of, e.g., w_{t,66} 314 spans approximately 800 subcarriers (i.e., 800*SCS=800*120,000=96 MHz). However, when θₜ=45° 314, the “beam frequency effective region” 308 of, e.g., w_{t,177} 318 spans approximately 300 subcarriers (i.e., 300*SCS=300*120,000=36 MHz). Moreover, when θₜ=70° 320, the “beam frequency effective region” 310 of, e.g., w_{t,235} 322 spans approximately 200 subcarriers (i.e., 200*SCS=200*120,000=24 MHz).

Due to the “beam squint effect”, in one embodiment, more than one transmit beamforming vector, in general, is needed to “cover” the whole system bandwidth, subcarriers (SCs), or resource blocks (RBs). In one embodiment, these beams are, in some examples, consecutive, i.e., their associated steering angles are close to each other. In the figure, these beams are called “beam burst”. Thus, by shifting the transmit beamforming steering angle φₙ (or equivalently changing/switching/optimizing the transmit beamforming), the location of the frequency effective region is also shifted/changed. In other words, if the Tx node 202 switches the current transmit beamforming vector to a nearby transmit beamforming vector, the same channel path can still be used by the Rx node 204 to receive a transmitted signal from the Tx node 202, but on a different frequency region.

It is worth noting that, when the Rx node 204 has a small antenna array, e.g., Nᵣ=4,8 or 16, and therefore capable of beamforming, we have observed that the optimal receive beamforming vector for a transmit beamforming vector is also the optimal receive beamforming vector for other transmit beams within the said beam burst.

Accordingly, the subject matter herein allows a Tx node 202, e.g., a gNB to use two or more beams, each corresponding to a different beam frequency effective region, while reducing the “beam squint effect” and enhances the current TCI state framework to account for cases where a DL/UL signal/channel is associated with two or more TCI states.

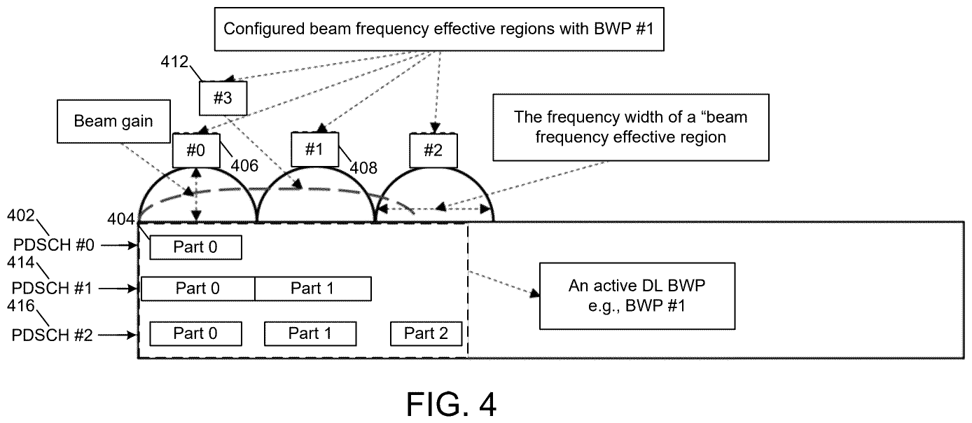

FIG. 4 illustrates an example of PDSCH channel frequency location/resources with respect to an active BWP and corresponding beam frequency effective regions in accordance with aspects of the present disclosure. In some examples, the allocated frequency resources (e.g., RBs, where each RB may comprise 12 consecutive SCs) of a DL/UL signal/channel by a gNB may be located within the frequency resources of a single beam frequency effective region, e.g., PDSCH #0 402. In this case, the channel/signal may have a single part 404 and can be transmitted/received using the associated transmit and receive spatial filters beam pair of the corresponding beam frequency effective region 406 as indicated by an associated TCI state.

However, in some other examples, the length of the allocated frequency resources of a DL/UL said signal/channel by gNB may exceed the frequency resources of a corresponding beam frequency effective region 406-412, e.g., PDSCH #1 414 and PDSCH #2 416. In such an embodiment, for example, the allocated frequency resources of PDSCH #1 414 are within the frequency resources of the 4th beam frequency effective region (i.e., #3 412), but it spans the frequency resources of the first and the second beam frequency effective regions (i.e., #0 406 and #1 408). Thus, PDSCH #1 414 can be transmitted and received using the associated transmit and receive beam pair of the 4th beam frequency effective region and the gNB may indicate that to the UE, e.g., using the current TCI state framework.

However, from the reliability and spectral efficiency viewpoint, it is more beneficial to use the associated transmit and receive beam pairs of first and second beam frequency effective regions (i.e., #0 406 and #1 408) as compared to using the associated transmit and receive beam pair of the 4th beam frequency effective region (i.e., #3 412), since the latter option has less beamforming gain as compared to the former option. Therefore, it may be beneficial to enhance the current TCI state framework to account for cases where a DL/UL signal/channel is associated with two or more TCI states. Accordingly, the subject matter herein allows a Tx node 202, e.g., a gNB to use two or more beams, each corresponding to a different beam frequency effective region, while reducing the “beam squint effect” and enhances the current TCI state framework to account for cases where a DL/UL signal/channel is associated with two or more TCI states.

In 5G NR, quasi colocation (QCL) and transmission configuration indicator (TCI) state are used by a network node, e.g., a gNB to inform a UE about assumptions it can make about two (or more) different channels/signals. In NR specification, the following QCL types are defined—QCL typeA: {Doppler shift, Doppler spread, average delay, delay spread}; QCL TypeB: {Doppler shift, Doppler spread}; QCL typeC: {Doppler shift, average delay}; and QCL typeD: {spatial RX parameter}.

The gNB (or other network node) can indicate a TCI state for a downlink channel/signal, which comprises one or more of corresponding QCLs between two downlink signals/channels: a reference and a target. Based on the indicated QCLs, the UE can optimize the receivers for the reception of the target downlink signal/channel.

For example, if a PDSCH channel and reference signal (RS) A are indicated to be QCL'd with respect to the QCL-typeB, the UE may assume that the large-scale parameters of Doppler shift and Doppler spread of the wireless channels of the PDSCH, and the RS A are the same. In this case, the UE may estimate the large-scale parameters via RS A, and then use them to optimize the channel estimation for PDSCH demodulation RS (DM-RS), which may improve the reception performance of the PDSCH.

On the other hand, QCL-typeD provides information to a UE so that it can determine the receive beam to be used for receiving a downlink signal/channel. For example, if a PDSCH channel and RS A are indicated to be QCL′d with respect to QCL-typeD, the UE may consider using the same receive beam that it determined to receive the RS A to receive the PDSCH transmission.

A UE may be configured with one or more TCI states, which can be configured/indicated by a combination of RRC signaling, MAC CE, and DCI signaling. A TCI state may include a TCI state ID, and a TCI state configuration, which contains the following content-QCL type: which can be one of QCL-typeA, QCL-typeB, QCL-typeC, or QCL-typeD; and/or QCL RS: which includes cell ID, BWP ID, and RS identification.

Table 1 shows the RSs allowed in a TCI state for different types of target signals/channels. Note that, with FR1, where QCL-TypeD is not applicable, a TCI state contains only a single RS, which provides the target signal/channel with the large-scale parameters corresponding to a QCL-Type A/B/C of an indicated RS. With FR2, where QCL-TypeD is applicable, a TCI state contains two RSs, where the first RS provides the target signal/channel with the large-scale parameters corresponding to a QCL-Type A/B/C and the second RS provides the target signal/channel with the large-scale parameters corresponding to a QCL-Type D.

For example, for periodic-tracking reference signal (P-TRS), there are two different TCI state configurations. With Configuration 1, the QCL-typeC parameters can be obtained from a Synchronization Signal Block (SSB). In the case of FR2, i.e., QCL-TypeD is applicable, RS #2 is also configured, and the UE can use the same beam (i.e., the same spatial RX filter) as it used for the reception of an SSB. With Configuration 2, the QCL-typeC parameters can be obtained from an SSB. In the case of FR2, i.e., QCL-TypeD is applicable, RS #2 is also configured, and the UE can use the same beam as it used for the reception of a Channel State Information Reference Signal (CSI-RS) for beam management (BM).

| Target | TCI state | | | DL RS #2 | QCL-Type2 |
|---|---|---|---|---|---|
| signal/ | configu- | DL RS | QCL- | (if | (if |
| channel | ration | #1 | Type1 | configured) | configured) |
| P-TRS | 1 | SSB | QCL- | SSB | QCL-TypeD |
| (Periodic- | | | TypeC | | |
| Tracking | 2 | SSB | QCL- | CSI-RS for | QCL-TypeD |
| Reference | | | TypeC | BM | |
| Signal) | | | | | |
| AP-TRS | 1 | P-TRS | QCL- | P-TRS | QCL-TypeD |
| (Aperiodic- | | | TypeC | | |
| TRS) | | | | | |
| CSI-RS for | 1 | P-TRS | QCL- | SSB | QCL-TypeD |
| CSI | | | TypeA | | |
| | 2 | P-TRS | QCL- | P-TRS | QCL-TypeD |
| | | | TypeA | | |
| | 3 | P-TRS | QCL- | CSI-RS for | QCL-TypeD |
| | | | TypeA | BM | |
| | 4 | P-TRS | QCL- | — | QCL-TypeD |
| | | | TypeB | | |
| CSI-RS for | 1 | P-TRS | QCL- | P-TRS | QCL-TypeD |
| BM | | | TypeA | | |
| | 2 | P-TRS | QCL- | CSI-RS for | QCL-TypeD |
| | | | TypeA | BM | |
| | 3 | SSB | QCL- | SSB | QCL-TypeD |
| | | | TypeC | | |
| DM-RS of | 1 | P-TRS | QCL- | P-TRS | QCL-TypeD |
| PDCCH/ | | | TypeA | | |
| PDSCH | 2 | P-TRS | QCL- | CSI-RS for | QCL-TypeD |
| | | | TypeA | BM | |
| | 3 | CSI-RS | QCL- | CSI-RS for | QCL-TypeD |
| | | for CSI | TypeA | CSI | |

For a discussion on bandwidth parts (BWP), see Section “12: Bandwidth part operation” of 3GPP TS 38.213 V18.3.0 (2024-06), incorporated herein by reference.

According to one embodiment, a network node, e.g., a gNB configures and signals a plurality of DL and/or UL BWPs to a UE, e.g., via an RRC, a MAC CE, and/or a DCI message, where each BWP may be characterized by a BWP index, a SCS, a start RB, and a length of RBs.

In some examples, one DL BWP and one UL BWP are indicated to be active, while the remaining BWPs are indicated as inactive. The active DL and UL BWPs may have the same BWP index and may share the same central frequency, at least with the unpaired Time Division Duplex (TDD) mode.

For one or more of configured BWPs, the gNB may determine and configure one or more beam frequency effective regions, where each beam frequency effective region may be characterized by a beam frequency effective region index, a start RB, a length of RBs, and a spatial filter beam pair for transmission and reception. The gNB may configure each BWP with an integer multiple of beam frequency effective regions.

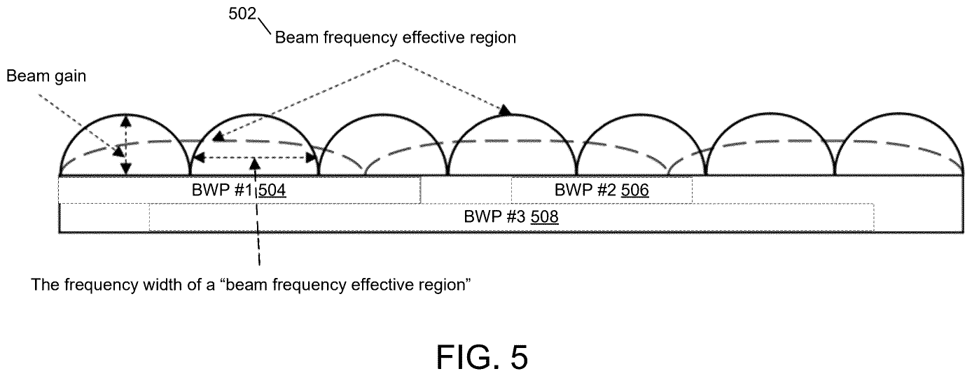

FIG. 5 illustrates an example of BWPs and beam effective regions in accordance with aspects of the present disclosure. In one implementation, a BWP 504-508 may be configured as a subset of resource blocks (RBs) from a beam frequency effective region 502. The gNB may configure and signal a plurality of TCI states corresponding to each of the beam frequency effective region, e.g., via a combination of an RRC, a MAC CE, and a DCI message signaling.

In some embodiments, every beam frequency effective region 502 is associated with a transmit and a receive spatial filter beam pair or a set of transmit and receive spatial filter beams. In some examples, one or more beam frequency effective regions 502 may share a common transmit spatial beam or a receive spatial beam.

In some embodiments, the gNB may determine one or more beam frequency effective regions 502 within each BWP 504-508 configured to or selected by a UE, e.g., via a random-access procedure (e.g., by reception of Msg. 1 and/or Msg. 3) or via reception of CSI reports from the UE, or via reception of UL RSs (e.g., sounding reference signals (SRSs)).

In some implementations, the gNB may configure and signal one or more of the determined beam frequency effective regions to a UE via, e.g., an RRC, a MAC CE, and/or a DCI message, where each beam frequency effective region may be indicated via a start RB and a length of RBs, separately or jointly encoded via a resource indicator value (RIV) (i.e., a similar method to that used to indicate a BWP 504-508).

In some examples, only a plurality of determined beam frequency effective regions within one or more indicated BWPs are configured and signaled to the UE. In some other examples, the gNB may activate one or more configured beam frequency effective regions 502 e.g., using a bitmap indicator.

In an embodiment, the gNB may schedule or configure a DL/UL signal/channel to a UE (e.g., a PDSCH, physical downlink control channel (PDCCH), physical uplink shared channel (PUSCH), physical uplink control channel (PUCCH), SRS, or the like), where the scheduling/configuration message includes the allocated frequency resources of the signal/channel, e.g., using the frequency domain resource allocation (FDRA) Type 0 or Type 1. The gNB may determine the frequency resource parts of the signal/channel that overlap with the predetermined/preconfigured beam frequency effective regions. The gNB and UE may transmit and receive the signal/channel, where each part of the channel/signal is transmitted and received using the associated transmit and receive spatial filters beam pair of the corresponding beam frequency effective region as indicated by an associated TCI state. In other words, if the signal/channel has multiple parts, where each part is located/associated with a different beam frequency effective region, the signal/channel is associated with multiple TCI states, where each TCI state is associated with a part of the signal/channel.

In one embodiment, if the UE is configured by the gNB with a plurality of beam frequency effective regions, the gNB may configure and signal a plurality of TCI state sets to the UE, e.g., using a higher layer RRC signaling message, where the ith TCI state set contains Nᵢ TCI states, and where the UE may assume that the ith TCI state set is associated with the ith beam frequency effective region. In other words, the applicable frequency resources of each TCI state are determined from the frequency resources of the associated beam frequency effective region.

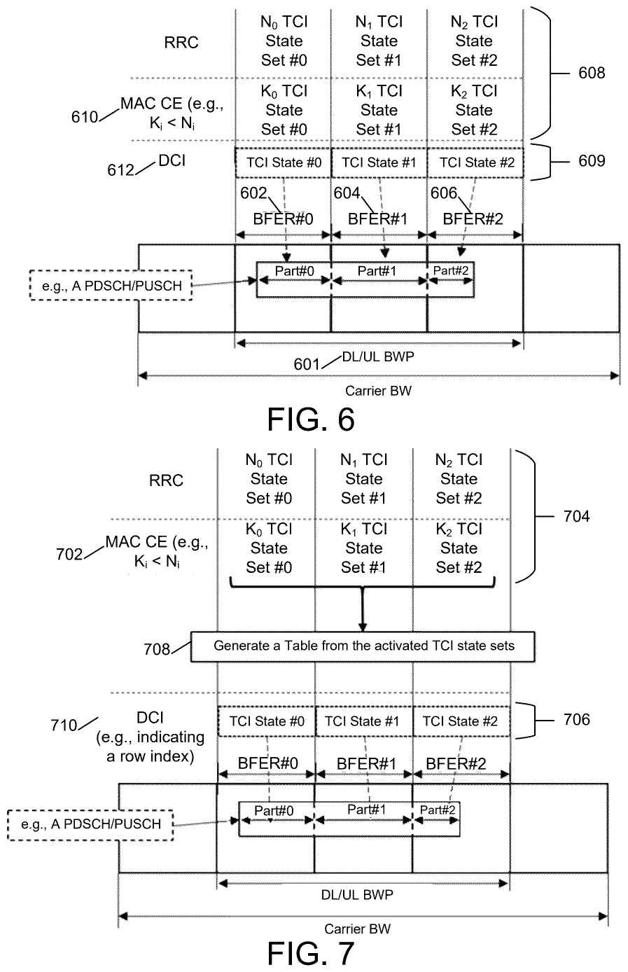

FIG. 6 illustrates an example of TCI indication in accordance with aspects of the present disclosure. In one embodiment, if an active DL/UL BWP 601 is configured with three beam frequency effective regions 602-606, the gNB may configure three TCI state sets 608, each for a beam frequency effective region 602-606, as shown in FIG. 6.

In some embodiments, the configured TCI state sets 608 are signal/channel specific. In some other embodiments, the configured TCI state sets 608 are common for all signals/channels. If Nᵢ=1, (i.e., the ith TCI state set 608 has a single TCI state 609) the configured TCI state 609 of the ith set (that is associated with the ith beam frequency effective region) is used when receiving the ith part of the said signal/channel that is located within the ith beam frequency effective region. If Nᵢ>1, (i.e., the ith TCI state set 608 has two or more TCI states 609) the gNB may use one of the following options to indicate a TCI state 609 to be used when transmitting and receiving the ith part of the said signal/channel:

In a first option, the gNB may use a MAC CE 610 signaling message to activate a TCI state 609 for the ith set (i.e., Kᵢ=1 in FIG. 6) to be used when receiving the ith part of the said signal/channel that is located within the frequency resources of the ith beam frequency effective region.

In a second option, the gNB may use a MAC CE 610 signaling message first to activate a plurality of TCI states 609 from the configured Nᵢ TCI states 609 of the ith set (i.e., Kᵢ>1 in FIG. 6). The gNB may thereafter use a DCI message 612 to indicate a TCI state 609 for the ith set to be used when receiving the ith part of the said signal/channel that is located within the frequency resources of the ith beam frequency effective region.

FIG. 7 illustrates an example of TCI indication in accordance with aspects of the present disclosure. In a third option, shown in FIG. 7, the gNB may use first a MAC CE 702 signaling message to activate a plurality of TCI states 706 from the configured Nᵢ TCI states 706 of the ith set (i.e., Kᵢ>1). The activated TCI states 706 from all TCI state sets 704 are then ordered and grouped, e.g., within a table 708, using a predefined ordering-and-grouping rule, wherein the table 708 contains all the combinations of possible TCI states 706 from all TCI state sets 704, where, in some table rows, only one TCI state 706 of a TCI state set 704 is mapped, while in some other table rows, two or more TCI states 706 from two or more TCI state sets 704 are mapped.

In some embodiments, the activating MAC CE 702 message indicates the grouping level. For example, Level 1 (L1) may indicate that the configured TCI states 706 from all TCI state sets 704 are stacked, e.g., on top of each other so that every row index indicates a single TCI state 706. Similarly, Level 2 (L2) may indicate that the configured TCI states 706 from all TCI state sets 704 are grouped in a way that every row index indicates two different TCI states 706, wherein each TCI state 706 is associated with a different beam frequency effective region.

In some other embodiments, the activating MAC CE 702 message indicates the TCI state sets 704 where the defined ordering-and-grouping rule is applied on, e.g., using a bitmap indicator. The gNB may use a scheduling DCI message 710 to indicate a row index to indicate the TCI state(s) 706 to be used when transmitting and receiving the signal/channel part located within the corresponding beam frequency effective region.

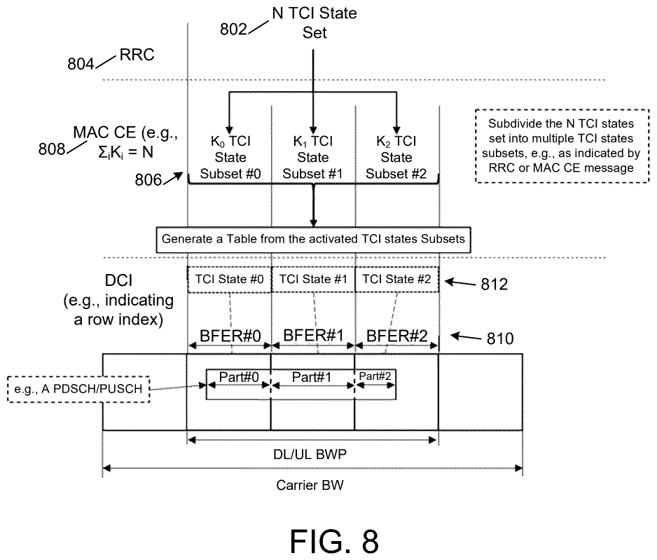

FIG. 8 illustrates an example of TCI indication in accordance with aspects of the present disclosure. In one embodiment, the gNB may configure and signal a TCI state set 802 containing a plurality of TCI states 812 (e.g., 128 TCI states) to a UE using, e.g., a higher layer RRC 804 signaling message.

In some embodiments, the UE may subdivide the configured TCI state set 802 into a plurality of subsets 806 using a predefined rule/method or as indicated by gNB (e.g., using RRC 804 or MAC CE 808 message), wherein the ith TCI states subset 806 is associated with the ith beam frequency effective region 810.

In some embodiments, when using a predefined rule, if the UE is explicitly configured with beam frequency effective regions 810, e.g., two beam frequency effective regions and is configured with a TCI state set 802 containing TCI states 812, e.g., 128 TCI states, the UE may assume that the 128 TCI states are subdivided into two 64 TCI states subsets 806 (e.g., the first subset is formed by the first 64 TCI states group, while the second subset is formed by the second 64 TCI states group). In such an embodiment, the first TCI states subset 806 is associated with the first beam frequency effective region 810 and the second TCI states subset 806 is associated with the second beam frequency effective region 810.

In some other embodiments, the gNB may indicate to the UE within a message, e.g., an RRC 804 or a MAC CE 808 message, the TCI states subdivision 806 and the associated beam frequency effective regions 810. For instance, the gNB may transmit a bitmap indicator within the message to the UE to indicate the subdivision 806 of the TCI states and the associated beam frequency effective regions 810.

In one embodiment, if the ith TCI state subset 806 has a single TCI state, the configured TCI state 812 of the ith subset (that is associated with the ith beam frequency effective region) is used when receiving the ith part of a configured/scheduled DL signal/channel that is located within the ith beam frequency effective region 810. In one embodiment, if the ith TCI state subset 806 has a plurality of TCI states 812, the gNB may use Options 1, 2, or 3 as discussed above, by changing “set” to “subset”. In yet another embodiment, the gNB may indicate multiple TCI states 812, where each indicated TCI state configuration corresponding to a TCI state 812 may include the associated beam effective frequency region index.

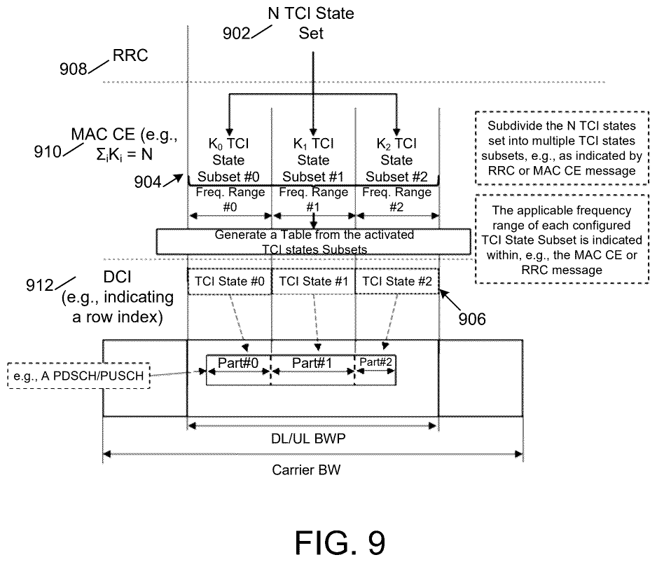

FIG. 9 illustrates an example of TCI indication in accordance with aspects of the present disclosure. In one embodiment, if the UE is not explicitly configured by the gNB with a plurality of beam frequency effective regions, the above embodiments for non-transparent mode can be updated/rephrased, as shown in FIG. 9, so that the associated frequency range of each TCI state set 902, TCI state subset 904, and/or each TCI state 906 is explicitly indicated by a message, e.g., an RRC 908, MAC CE 910, or DCI 912 message or within the TCI state configuration. In one embodiment, the associated frequency range of each TCI states set 902, TCI state subset 904, or TCI state 906 may be characterized by a starting RB and a length of RBs. In other words, the applicable frequency resources/ranges of each TCI state 906 are explicitly signaled within the TCI state configuration message.

In some embodiments, the UE may determine each part of the signal/channel as an intersection between the scheduled/configured frequency domain resources of the signal/channel and the configured frequency domain region of a beam frequency effective region or as an intersection between the scheduled/configured frequency domain resources of the said signal/channel and the indicated/configured frequency resources range associated with an indicated TCI state 906.

In one embodiment, the frequency resources of each signal/channel part are explicitly indicated within the signal/channel configuration message. In other words, the applicable frequency resources/range of each TCI state 906 are signaled within the signal/channel configuration message. In such an embodiment, the UE may process (i.e., receive or transmit) the signal/channel such that each part of the signal/channel is processed using the associated TCI state 906.

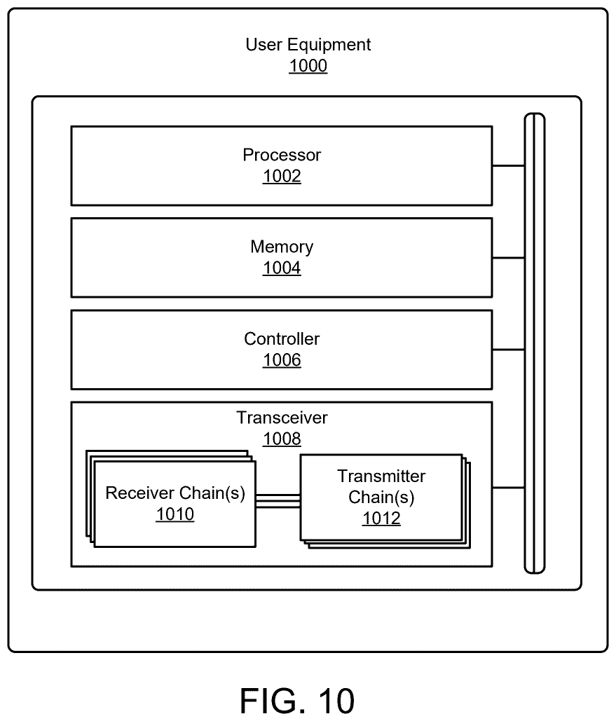

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may receive a first configuration message comprising an indication of one or more TCI state sets, wherein each TCI state set of the one or more TCI state sets comprises one or more TCI states. The UE 1000 may receive a second configuration message comprising configuration information for scheduling a downlink channel or signal or an uplink channel or signal, wherein frequency resources that are allocated to a scheduled downlink channel or signal or a scheduled uplink channel or signal comprise a plurality of channel parts or signal parts, and wherein the second configuration message further comprises an indication of a plurality of TCI states associated with the plurality of channel parts or signal parts of the scheduled downlink channel or signal or the scheduled uplink channel or signal. The UE 1000 may communicate in accordance with processing the plurality of channel parts or signal parts of the scheduled downlink channel or signal or the scheduled uplink channel or signal using the associated plurality of TCI states.

In one embodiment, the UE 1000 may receive a third configuration message for configuring one or more beam frequency effective regions, wherein each beam frequency effective region of the one or more beam frequency effective regions is associated with one TCI state set of the one or more TCI state sets, and wherein each beam frequency effective region of the one or more beam frequency effective regions is associated with at least one of a beam frequency effective region index, a starting RB, an RB length, a spatial filter beam pair for transmission and reception, or a combination thereof.

In one embodiment, the one or more TCI state sets are subdivided into a plurality of TCI state subsets, and wherein each TCI state subset of the plurality of TCI state subsets is associated with one beam frequency effective region of one or more configured beam frequency effective regions. In one embodiment, to receive the first configuration messages, the UE 1000 may receive the first configuration message using higher-layer RRC signaling.

In one embodiment, the UE 1000 may receive a MAC CE signaling that activates the one or more TCI states of the one or more TCI state sets. In one embodiment, the UE 1000 may create a table comprising a plurality of row indices and a plurality of column indices associated with the one or more TCI states, wherein each row index or each column index indicates the one or more TCI states.

In one embodiment, to create the table, the UE 1000 may create the table according to a predefined rule or an indication received from a network node. In one embodiment, the first configuration message comprises an indication of a frequency resource range of the one or more TCI states.

In one embodiment, the UE 1000 may determine the plurality of channel parts or signal parts of the scheduled downlink channel or signal, or uplink channel or signal based on an intersection between scheduled frequency domain resources of the scheduled downlink or uplink channel and configured frequency domain resources of beam frequency effective regions.

In one embodiment, the UE 1000 may determine the plurality of channel parts or signal parts of the scheduled downlink channel or signal or uplink channel or signal based on an intersection between scheduled frequency domain resources of the scheduled downlink or uplink channel and configured frequency resource ranges associated with the one or more TCI states. In one embodiment, the second configuration message indicates frequency resources and associated TCI states for the plurality of channel parts or signal parts of the scheduled downlink channel or signal or uplink channel or signal.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding and processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

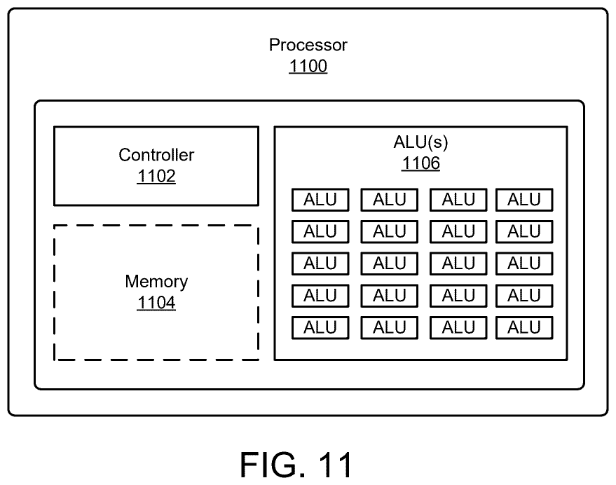

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory address of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, arithmetic logic units (ALUs), and other functional units of the processor 1100.

The memory 1104 may include one or more caches (e.g., memory local to or included in the processor 1100 or other memory, such RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, the controller 1102, and the memory 1104 may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may receive a first configuration message comprising an indication of one or more TCI state sets, wherein each TCI state set of the one or more TCI state sets comprises one or more TCI states. The processor 1100 may receive a second configuration message comprising configuration information for scheduling a downlink channel or signal or an uplink channel or signal, wherein frequency resources that are allocated to a scheduled downlink channel or signal or a scheduled uplink channel or signal comprise a plurality of channel parts or signal parts, and wherein the second configuration message further comprises an indication of a plurality of TCI states associated with the plurality of channel parts or signal parts of the scheduled downlink channel or signal or the scheduled uplink channel or signal. The processor 1100 may communicate in accordance with processing the plurality of channel parts or signal parts of the scheduled downlink channel or signal or the scheduled uplink channel or signal using the associated plurality of TCI states.

In one embodiment, the processor 1100 may receive a third configuration message for configuring one or more beam frequency effective regions, wherein each beam frequency effective region of the one or more beam frequency effective regions is associated with one TCI state set of the one or more TCI state sets, and wherein each beam frequency effective region of the one or more beam frequency effective regions is associated with at least one of a beam frequency effective region index, a starting RB, an RB length, a spatial filter beam pair for transmission and reception, or a combination thereof.

In one embodiment, the one or more TCI state sets are subdivided into a plurality of TCI state subsets, and wherein each TCI state subset of the plurality of TCI state subsets is associated with one beam frequency effective region of one or more configured beam frequency effective regions. In one embodiment, to receive the first configuration messages, the processor 1100 may receive the first configuration message using higher-layer RRC signaling.

In one embodiment, the processor 1100 may receive a MAC CE signaling that activates the one or more TCI states of the one or more TCI state sets. In one embodiment, the processor 1100 may create a table comprising a plurality of row indices and a plurality of column indices associated with the one or more TCI states, wherein each row index or each column index indicates the one or more TCI states.

In one embodiment, to create the table, the processor 1100 may create the table according to a predefined rule or an indication received from a network node. In one embodiment, the first configuration message comprises an indication of a frequency resource range of the one or more TCI states.

In one embodiment, the processor 1100 may determine the plurality of channel parts or signal parts of the scheduled downlink channel or signal or uplink channel or signal based on an intersection between scheduled frequency domain resources of the scheduled downlink or uplink channel and configured frequency domain resources of beam frequency effective regions.

In one embodiment, the processor 1100 may determine the plurality of channel parts or signal parts of the scheduled downlink channel or signal or uplink channel or signal based on an intersection between scheduled frequency domain resources of the scheduled downlink or uplink channel and configured frequency resource ranges associated with the one or more TCI states. In one embodiment, the second configuration message indicates frequency resources and associated TCI states for the plurality of channel parts or signal parts of the scheduled downlink channel or signal or uplink channel or signal.

In one embodiment, the processor 1100 is configured to determine one or more TCI state sets comprising one or more TCI states; transmit a first configuration message comprising an indication of the one or more TCI state sets; determine information for scheduling a downlink channel or signal or an uplink channel or signal, wherein frequency resources that are allocated to the scheduled downlink channel or signal or uplink channel or signal comprise a plurality of channel parts or signal parts; determine a plurality of TCI states associated with the plurality of channel parts or signal parts of the scheduled downlink channel or signal or uplink channel or signal; and transmit a second configuration message comprising the information for scheduling the downlink channel or signal or uplink channel or signal and an indication of the plurality of TCI states associated with the plurality of channel parts or signal parts.

In one embodiment, the processor 1100 is configured to determine one or more beam frequency effective regions associated with the one or more TCI states based on a random-access procedure, CSI reports, uplink reference signals, or a combination thereof, wherein the one or more beam frequency effective regions are associated with a beam frequency effective region index, a starting RB, an RB length, a spatial filter beam pair for transmission and reception, or a combination thereof, and transmit a third configuration message comprising the one or more beam frequency effective regions.

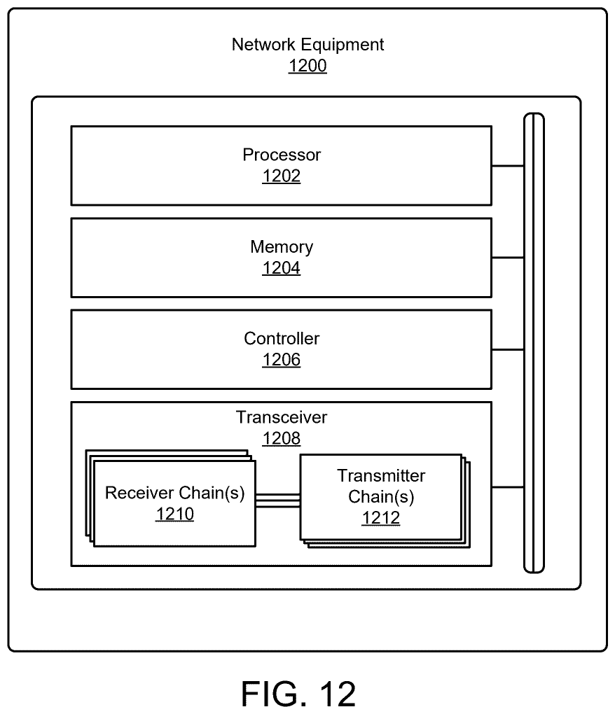

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein.

In one embodiment, the NE 1200 is configured to determine one or more TCI state sets comprising one or more TCI states; transmit a first configuration message comprising an indication of the one or more TCI state sets; determine information for scheduling a downlink channel or signal or an uplink channel or signal, wherein frequency resources that are allocated to the scheduled downlink channel or signal or uplink channel or signal comprise a plurality of channel parts or signal parts; determine a plurality of TCI states associated with the plurality of channel parts or signal parts of the scheduled downlink channel or signal or uplink channel or signal; and transmit a second configuration message comprising the information for scheduling the downlink channel or signal or uplink channel or signal and an indication of the plurality of TCI states associated with the plurality of channel parts or signal parts.

In one embodiment, the NE 1200 is configured to determine one or more beam frequency effective regions associated with the one or more TCI states based on a random-access procedure, CSI reports, uplink reference signals, or a combination thereof, wherein the one or more beam frequency effective regions are associated with a beam frequency effective region index, a starting RB, an RB length, a spatial filter beam pair for transmission and reception, or a combination thereof, and transmit a third configuration message comprising the one or more beam frequency effective regions.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding and processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

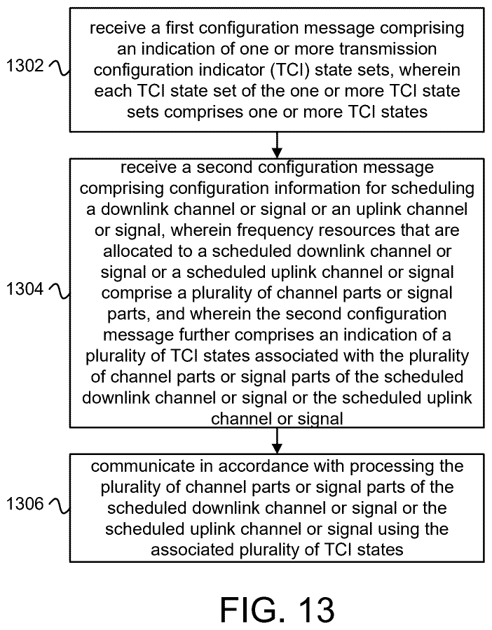

FIG. 13 illustrates a flowchart of a method in accordance with aspects of the present disclosure. The operations of the method may be implemented by a UE as described herein. In some implementations, the UE may execute a set of instructions to control the function elements of the UE to perform the described functions.

At 1302, the method may receive a first configuration message comprising an indication of one or more TCI state sets, wherein each TCI state set of the one or more TCI state sets comprises one or more TCI states. The operations of 1302 may be performed in accordance with examples as described herein. In some implementations, aspects of the operations of 1302 may be performed by a UE as described with reference to FIG. 10.

At 1304, the method may receive a second configuration message comprising configuration information for scheduling a downlink channel or signal or an uplink channel or signal, wherein frequency resources that are allocated to a scheduled downlink channel or signal or a scheduled uplink channel or signal comprise a plurality of channel parts or signal parts, and wherein the second configuration message further comprises an indication of a plurality of TCI states associated with the plurality of channel parts or signal parts of the scheduled downlink channel or signal or the scheduled uplink channel or signal. The operations of 1304 may be performed in accordance with examples as described herein. In some implementations, aspects of the operations of 1304 may be performed by a UE as described with reference to FIG. 10.

At 1306, the method may communicate in accordance with processing the plurality of channel parts or signal parts of the scheduled downlink channel or signal or the scheduled uplink channel or signal using the associated plurality of TCI states. The operations of 1306 may be performed in accordance with examples as described herein. In some implementations, aspects of the operations of 1306 may be performed by a UE as described with reference to FIG. 10.

It should be noted that the method described herein describes A possible implementation, and that the operations and the steps may be rearranged or otherwise modified and that other implementations are possible.

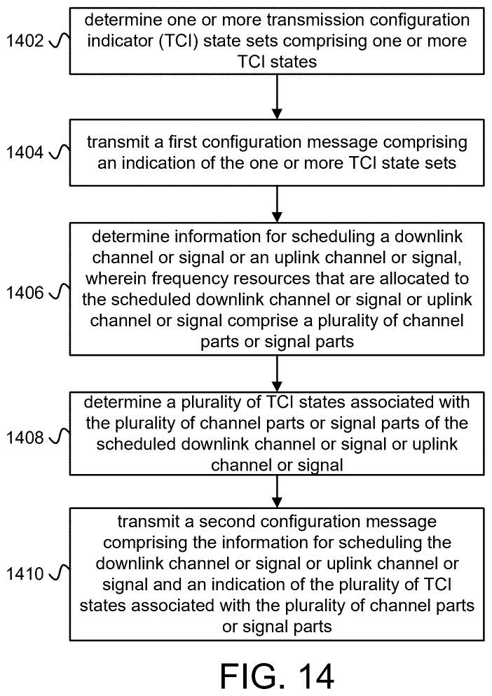

FIG. 14 illustrates a flowchart of a method in accordance with aspects of the present disclosure. The operations of the method may be implemented by a NE as described herein. In some implementations, the NE may execute a set of instructions to control the function elements of the NE to perform the described functions.

At 1402, the method may determine one or more transmission configuration indicator (TCI) state sets comprising one or more TCI states. The operations of 1402 may be performed in accordance with examples as described herein. In some implementations, aspects of the operations of 1402 may be performed by a NE as described with reference to FIG. 12.

At 1404, the method may transmit a first configuration message comprising an indication of the one or more TCI state sets. The operations of 1404 may be performed in accordance with examples as described herein. In some implementations, aspects of the operations of 1404 may be performed by a NE as described with reference to FIG. 12.

At 1406, the method may determine information for scheduling a downlink channel or signal or an uplink channel or signal, wherein frequency resources that are allocated to the scheduled downlink channel or signal or uplink channel or signal comprise a plurality of channel parts or signal parts. The operations of 1406 may be performed in accordance with examples as described herein. In some implementations, aspects of the operations of 1406 may be performed by a NE as described with reference to FIG. 12.

At 1408, the method may determine a plurality of TCI states associated with the plurality of channel parts or signal parts of the scheduled downlink channel or signal or uplink channel or signal. The operations of 1408 may be performed in accordance with examples as described herein. In some implementations, aspects of the operations of 1408 may be performed by a NE as described with reference to FIG. 12.

At 1410, the method may transmit a second configuration message comprising the information for scheduling the downlink channel or signal or uplink channel or signal and an indication of the plurality of TCI states associated with the plurality of channel parts or signal parts. The operations of 1410 may be performed in accordance with examples as described herein. In some implementations, aspects of the operations of 1410 may be performed by a NE as described with reference to FIG. 12.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a first configuration message comprising an indication of one or more transmission configuration indicator (TCI) state sets, wherein each TCI state set of the one or more TCI state sets comprises one or more TCI states;
receive a second configuration message comprising configuration information for scheduling a downlink channel or signal or an uplink channel or signal, wherein frequency resources that are allocated to a scheduled downlink channel or signal or a scheduled uplink channel or signal comprise a plurality of channel parts or signal parts, and wherein the second configuration message further comprises an indication of a plurality of TCI states associated with the plurality of channel parts or signal parts of the scheduled downlink channel or signal or the scheduled uplink channel or signal; and
communicate in accordance with processing the plurality of channel parts or signal parts of the scheduled downlink channel or signal or the scheduled uplink channel or signal using the associated plurality of TCI states.

2. The UE of claim 1, wherein the at least one processor is configured to cause the UE to:
receive a third configuration message for configuring one or more beam frequency effective regions, wherein each beam frequency effective region of the one or more beam frequency effective regions is associated with one TCI state set of the one or more TCI state sets, and wherein each beam frequency effective region of the one or more beam frequency effective regions is associated with at least one of a beam frequency effective region index, a starting resource block (RB), an RB length, a spatial filter beam pair for transmission and reception, or a combination thereof.

3. The UE of claim 2, wherein the one or more TCI state sets are subdivided into a plurality of TCI state subsets, and wherein each TCI state subset of the plurality of TCI state subsets is associated with one beam frequency effective region of one or more configured beam frequency effective regions.

4. The UE of claim 1, wherein to receive the first configuration messages, the at least one processor is configured to cause the UE to:
receive the first configuration message using higher-layer radio resource control (RRC) signaling.

5. The UE of claim 1, wherein the at least one processor is configured to cause the UE to:
receive a media access control (MAC) control element (CE) signaling that activates the one or more TCI states of the one or more TCI state sets.

6. The UE of claim 1, wherein the at least one processor is configured to cause the UE to:
create a table comprising a plurality of row indices and a plurality of column indices associated with the one or more TCI states, wherein each row index or each column index indicates the one or more TCI states.

7. The UE of claim 6, wherein to create the table, the at least one processor is configured to cause the UE to:
create the table according to a predefined rule or an indication received from a network node.

8. The UE of claim 1, wherein the first configuration message comprises an indication of a frequency resource range of the one or more TCI states.

9. The UE of claim 1, wherein the at least one processor is configured to cause the UE to:
determine the plurality of channel parts or signal parts of the scheduled downlink channel or signal or uplink channel or signal based on an intersection between scheduled frequency domain resources of the scheduled downlink or uplink channel and configured frequency domain resources of beam frequency effective regions.

10. The UE of claim 1, wherein the at least one processor is configured to cause the UE to:
determine the plurality of channel parts or signal parts of the scheduled downlink channel or signal or uplink channel or signal based on an intersection between scheduled frequency domain resources of the scheduled downlink or uplink channel and configured frequency resource ranges associated with the one or more TCI states.

11. The UE of claim 1, wherein the second configuration message indicates frequency resources and associated TCI states for the plurality of channel parts or signal parts of the scheduled downlink channel or signal or uplink channel or signal.

12. A processor for wireless communication, comprising:
at least one controller coupled with at least one memory and configured to cause the processor to:
receive a first configuration message comprising an indication of one or more transmission configuration indicator (TCI) state sets, wherein each TCI state set of the one or more TCI state sets comprises one or more TCI states;
receive a second configuration message comprising configuration information for scheduling a downlink channel or signal or an uplink channel or signal, wherein frequency resources that are allocated to a scheduled downlink channel or signal or a scheduled uplink channel or signal comprise a plurality of channel parts or signal parts, and wherein the second configuration message further comprises an indication of a plurality of TCI states associated with the plurality of channel parts or signal parts of the scheduled downlink channel or signal or the scheduled uplink channel or signal; and
communicate in accordance with processing the plurality of channel parts or signal parts of the scheduled downlink channel or signal or the scheduled uplink channel or signal using the associated plurality of TCI states.

13. The processor of claim 12, wherein the at least one controller is configured to cause the processor to:
receive a third configuration message for configuring one or more beam frequency effective regions, wherein each beam frequency effective region of the one or more beam frequency effective regions is associated with one TCI state set of the one or more TCI state sets, and wherein each beam frequency effective region of the one or more beam frequency effective regions is associated with at least one of a beam frequency effective region index, a starting resource block (RB), an RB length, a spatial filter beam pair for transmission and reception, or a combination thereof.

14. The processor of claim 13, wherein the one or more TCI state sets are subdivided into a plurality of TCI state subsets, and wherein each TCI state subset of the plurality of TCI state subsets is associated with one beam frequency effective region of one or more configured beam frequency effective regions.

15. The processor of claim 12, wherein the at least one controller is configured to cause the processor to:
receive the first configuration message using higher-layer radio resource control (RRC) signaling.

16. The processor of claim 12, wherein the at least one controller is configured to cause the processor to:
receive a media access control (MAC) control element (CE) signaling that activates the one or more TCI states of the one or more TCI state sets.

17. The processor of claim 12, wherein the at least one controller is configured to cause the processor to:
create a table comprising a plurality of row indices and a plurality of column indices associated with the one or more TCI states, wherein each row index or each column index indicates the one or more TCI states.

18. A method of a user equipment (UE), comprising:
receiving a first configuration message comprising an indication of one or more transmission configuration indicator (TCI) state sets, wherein each TCI state set of the one or more TCI state sets comprises one or more TCI states;
receiving a second configuration message comprising configuration information for scheduling a downlink channel or signal or an uplink channel or signal, wherein frequency resources that are allocated to a scheduled downlink channel or signal or a scheduled uplink channel or signal comprise a plurality of channel parts or signal parts, and wherein the second configuration message further comprises an indication of a plurality of TCI states associated with the plurality of channel parts or signal parts of the scheduled downlink channel or signal or the scheduled uplink channel or signal; and
communicating in accordance with processing the plurality of channel parts or signal parts of the scheduled downlink channel or signal or the scheduled uplink channel or signal using the associated plurality of TCI states.

19. A network equipment (NE) for wireless communication, comprising:
at least one memory; and
at least one processor coupled with the at least one memory and configured to cause the NE to:
determine one or more transmission configuration indicator (TCI) state sets comprising one or more TCI states;
transmit a first configuration message comprising an indication of the one or more TCI state sets;
determine information for scheduling a downlink channel or signal or an uplink channel or signal, wherein frequency resources that are allocated to the scheduled downlink channel or signal or uplink channel or signal comprise a plurality of channel parts or signal parts;
determine a plurality of TCI states associated with the plurality of channel parts or signal parts of the scheduled downlink channel or signal or uplink channel or signal; and
transmit a second configuration message comprising the information for scheduling the downlink channel or signal or uplink channel or signal and an indication of the plurality of TCI states associated with the plurality of channel parts or signal parts.

20. The NE of claim 19, wherein the at least one processor is configured to cause the NE to:
determine one or more beam frequency effective regions associated with the one or more TCI states based on a random-access procedure, channel state information (CSI) reports, uplink reference signals, or a combination thereof, wherein the one or more beam frequency effective regions are associated with a beam frequency effective region index, a starting resource block (RB), an RB length, a spatial filter beam pair for transmission and reception, or a combination thereof; and
transmit a third configuration message comprising the one or more beam frequency effective regions.
